(19) United States
(12) Patent Application Publication
(10) Pub. No.: US 2026/0201973 A1
(43) Pub. Date: Jul. 16, 2026

(54) NON-RETURN VALVE

(71) Applicant: Viessmann Holding International GmbH, Allendorf (Eder) (DE)

(72) Inventor: Marco MÜLLER, Frankenberg (DE)

(73) Assignee: Viessmann Holding International GmbH, Allendorf (Eder) (DE)

(21) Appl. No.: 19/424,303

(22) Filed: Dec. 18, 2025

(30) Foreign Application Priority Data
Jan. 15, 2025 (DE) 10 2025 101 212.1

(51) Int. Cl. F16K 27/08; F16K 15/02; F16K 15/18

(52) U.S. Cl. CPC F16K 27/08; F16K 15/021; F16K 15/182

(57) ABSTRACT

A non-return valve includes a valve housing with an inflow region and with an outflow region, a valve body designed to be mounted movably in the valve housing to restrict flow between the inflow and outflow regions, and an actuating element designed to be operable from outside the valve housing in order to move the valve body. The valve housing is made up of two housing sections which are displaceable while sealed off from each other for operating the actuating element, wherein the valve body is mounted movably on one of the two housing sections, and wherein the actuating element that cooperates with the valve body is arranged in the other of the two housing sections.

### CROSS REFERENCE TO RELATED APPLICATIONS

Applicant claims priority under 35 U.S.C. §119 of German Application No. 10 2025 101 212.1 filed January 15, 2025, the disclosure of which is incorporated by reference.

### BACKGROUND OF THE INVENTION

### Field of the invention

The invention relates to a non-return valve.

### Description of the Related Art

A non-return valve of the kind referred to here is known from document EP 3225851 A1. This non-return valve consists of a valve housing with an inflow region and with an outflow region, a valve body mounted movably in the valve housing to restrict flow between the inflow and outflow regions, and an actuating element that is operable from outside the valve housing and designed to move the valve body. In this solution, a sealed access opening for the actuating element is provided on the valve housing, so that the actuating element can not only be gripped and operated by a user from outside the valve housings but is also constructed with a connection to the valve body inside the valve housing.

### SUMMARY OF THE INVENTION

The problem the invention is intended to address is that of improving a non-return valve of the kind referred to in the introduction. In particular, it is intended to create a non-return valve that functions particularly reliably.

This problem is solved with a non-return valve of the kind referred to in the introduction and having the features of the invention.

According to the invention, it is thus provided that in order to allow the actuating element to be operated, the valve housing is made up of two housing sections which are displaceable while sealed off from each other, wherein the valve body is mounted movably on one of the two housing sections, and wherein the actuating element that cooperates with the valve body is arranged in the other of the two housing sections.

In other words, the solution according to the invention is thus characterized in that an operative connection is made between the actuating element and the valve body through the interaction of the two housing sections, which are displaceable while sealed off from each other. At the same time, this solution is particularly reliable in comparison with the prior art as described in the introduction, because a seal is not needed on the actuating element itself.

Other advantageous developments of the non-return valve according to the invention are discussed below.

For the sake of completeness, reference is also made to the less closely related document EP 2896856 A1.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 is a cross-sectional view along line A-A of FIG. 7 of the non-return valve according to the invention in the closed position, i.e. in which fluid cannot pass;

FIG. 2 is a cross-sectional view along line A-A of FIG. 8 of the non-return valve according to the invention in the open position, i.e. in which fluid can pass;

FIG. 3 is a perspective view of the non-return valve according to FIG. 1, i.e. in the closed position, in which fluid cannot pass;

FIG. 4 is a perspective view of the non-return valve according to FIG. 2, i.e. in the open position, in which fluid can pass;

FIG. 5 is a side view of the non-return valve according to FIG. 1 in the closed position;

FIG. 6 is a side view of the non-return valve according to FIG. 2 in the open position;

FIG. 7 is a front view of the non-return valve according to FIG. 1 in the closed position; and

FIG. 8 is a front view of the non-return valve according to FIG. 2 in the open position.

### DETAILED DESCRIPTION OF PREFERRED EMBODIMENTS

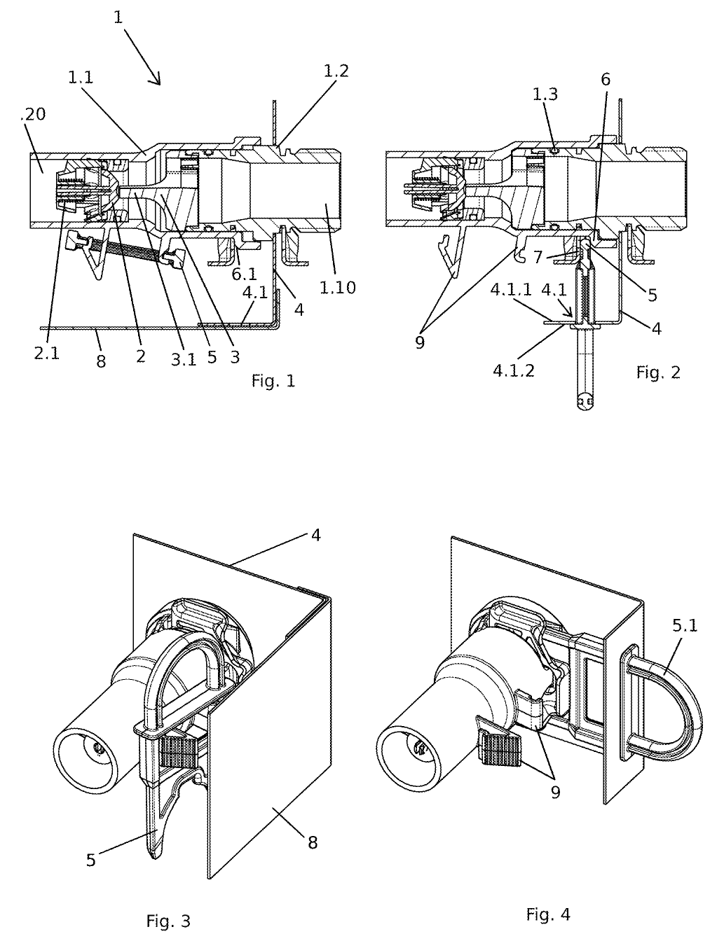

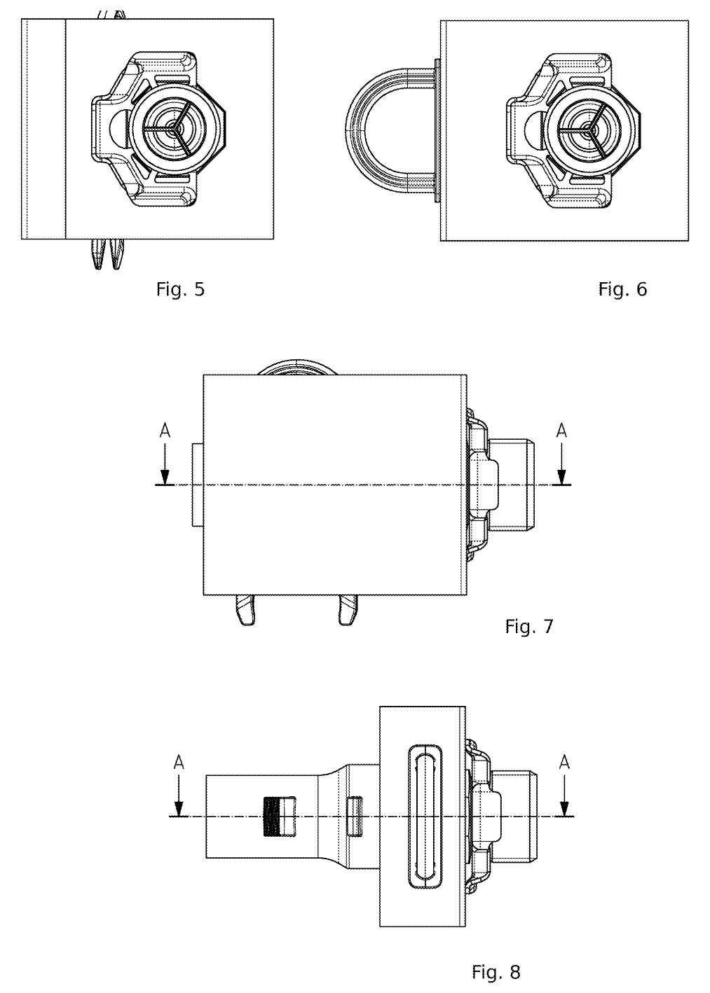

The non-return valve represented in FIGS. 1 to 8 that is provided for optionally allowing or preventing the passage of fluid, in particular water, consists in manner known per se, of a valve housing 1 with an inflow region 1.10 and with an outflow region 1.20, a valve body 2 (with its correspondingly fitting valve seat on the valve housing 1) designed to be mounted movably inside the valve housing 1 to restrict flow between the inflow and outflow regions 1.10, 1.20, and an actuating element 3 constructed to be operable from outside the valve housing 1 in order to move the valve body 2.

Given the above situation, a spring element 2.1, preferably a helical compression spring, is preferably provided between the housing section 1.1 and the valve body 2 and presses said valve body into the closure position. It is further preferably provided that the actuating element 3 is optionally designed to cooperate with the central region of the valve body 2, and/or includes a journal-like section 3.1 that cooperates with the valve body 2.

Now it is essential for the non-return valve according to the invention that to allow the actuating element 3 to be operated the valve housing 1 is formed from two housing sections 1.1, 1.2 that are displaceable while sealed off from each other, wherein the valve body 2 is mounted movably on one of the two housing sections 1.1, and wherein the actuating element 3 that cooperates with the valve body 2 is arranged in the other of the two housing sections 1.2.

Still more precisely, it is further preferably provided that the housing sections 1.1, 1.2 are at least of tubular construction. In this case, a tubular part of the one housing section 1.2 is particularly preferably arranged concentrically inside a tubular part of the other housing section 1.1, preferably in a movement-restricted and sealed manner.

To ensure that, apart from its inflow and outflow regions 1.10, 1.20 the non-return valve is otherwise fluid-tight, more precisely still at least one annular seal 1.3 (see FIG. 2), in particular an O-ring, is particularly preferably arranged between the tubular parts.

In order to enable the non-return valve according to the invention to be produced particularly easily, it is further preferably provided that the housing sections 1.1, 1.2 are made from plastic.

To enable particularly simple operation of the non-return valve according to the invention, it is further particularly preferable to provide a guide device 4 on one of the two housing sections 1.2 for a retaining element 5 that can be brought into operative connection with the other housing section 1.1. In this context, it is further particularly preferably provided that the guide device 4 is made optionally from metal, preferably sheet metal, and/or that the retaining element 5 is made from plastic.

More precisely still, it is particularly preferably provided for the purpose of operating the non-return valve according to the invention that said retaining element 5 is designed to cause a displacement of the housing sections 1.1., 1.2 towards each other when it is inserted in the guide device 4.

In this context it is further particularly preferable if an adjusting element 6, preferably having a guide bevel 6.1 and cooperating with the retaining element 5, is provided on the outside of the housing section 1.1 that accommodates the valve body 2 to displace the housing sections 1.1, 1.2 towards each other.

Also preferably, an abutment member 7 that is connected firmly but detachably to the housing section 1.2 that accommodates the actuating element 3 is assigned to this adjusting element 6, which is preferably designed as a pipe elbow. In addition, it is preferably provided that the retaining element 5 is designed to be insertable between the adjusting element 6 and the abutment member 7 to displace the housing sections 1.1, 1.2 towards each other, at the same time pressing them apart. In addition, it is also particularly preferably provided that the abutment member 7 is designed as a limit stop for the adjusting element 6 to prevent the housing sections 1.1, 1.2 from becoming detached from each other.

It is also preferably provided that the guide device 4 has a passthrough opening 4.1 to allow the retaining element 5 to be inserted. In this context, it is also preferably provided that the passthrough opening 4.1 has a side 4.1.1 facing towards the valve housing 1 and a side 4.1.2 facing away from the valve housing 1. It is also preferably provided that while acting on the housing sections 1.1, 1.2 (that is to say when the retaining element 5 is inserted) the retaining element 5 has a blocking part 5.1 that remains on the side 4.1.2 of the passthrough opening 4.1 facing away from the valve housing 1, whose function will be explained in more detail in the following text.

It is also preferably provided that when the retaining element 5 is not inserted (that is to say when the retaining element 5 is not acting on the housing sections 1.1, 1.2), the side 4.1.2 of the passthrough opening 4.1 facing away from the valve housing 1 is designed as a bearing surface for the housing part 8 (preferably of a thermotechnical device); this will also be described in more detail in the following text.

Finally, a stowing device 9 is preferably also provided on the valve housing 1 to accommodate or stow the retaining element 5 when it is not in use, and which is designed for example in the form of a holder, to which the retaining element 5 can be clipped.

### The non-return valve according to the invention functions as follows:

The starting point for this description is FIG. 3, in which the non-return valve according to the invention is represented with the valve body 2 in the closed position, wherein a housing part 8 also bears on the guide device 4. This position is typical for a heat pump when no fluid is being transported (or no fluid is present). In normal operation, that is to say when the heat pump is running under stable conditions, the housing sections 1.1 and 1.2 are also in the position shown in FIG. 3, although the valve body 2 is then in the open position as the fluid is being displaced.

However, if it then becomes necessary to drain the hydraulic system for this heat pump, for maintenance for example, or a reason of this kind, first the housing part 8, typically a cover element on the heat pump, is removed. This then allows access to the retaining element 5, which at this time is still on the stowing device 9 (see also FIG. 4) but can now be taken off. At the same time, removing the housing part 8 also gives access to the passthrough opening 4.1 (see also FIG. 1) on the guide device 4, and now the retaining element 5 can be inserted through the opening.

As may be discerned in particular by comparing FIGS. 1 and 2, insertion of the retaining element 5 between the adjusting element 6 and the abutment element 7 has the effect of displacing the housing section 1.1 towards the housing section 1.2 (i.e. to the right in the figures).

This displacement in turn causes the valve seat of the valve body 2 to be displaced (also to the right), wherein at the same time the actuating element 3 holds the valve body 2 in position, so that the non-return valve according to the invention as a whole moves to the open position, which also means that a fluid present in the inflow region 1.10 can pass through the valve body 2 to the outflow region 1.20, where it can flow out.

Since in this situation the blocking part 5.1 prevents the housing with the housing part 8 from closing again, it is assured – which is extremely important for operating a heat pump system of such kind – that said emptying must be completed before the housing part 8 is refitted. In this way, an operating error of the non-return valve according to the invention may be prevented unfailingly.

Although only a few embodiments of the present invention have been shown and described, it is to be understood that many changes and modifications may be made thereunto without departing from the spirit and scope of the invention.

### List of reference numerals

1 Valve housing

1.1 Housing section

1.2 Housing section

1.3 Annular seal

1.10 Inflow region

1.20 Outflow region

2 Valve body

2.1 Spring element

3 Actuating element

3.1 Section

4 Guide device

4.1 Passthrough opening

4.1.1 Side facing

4.1.2 Side facing away

5 Retaining element

5.1 Blocking part

6 Adjusting element

6.1 Guide bevel

7 Abutment member

8 Housing part

9 Stowing device

What is claimed is:

1. A non-return valve, comprising a valve housing (1) with an inflow region (1.10) and with an outflow region (1.20), a valve body (2) designed to be mounted movably in the valve housing (1) to restrict flow between the inflow and outflow regions (1.10, 1.20), and an actuating element (3) designed to be operable from outside the valve housing (1) in order to move the valve body (2),
wherein
the valve housing (1) is made up of two housing sections (1.1, 1.2) which are displaceable while sealed off from each other for operating the actuating element (3), wherein the valve body (2) is mounted movably on one of the two housing sections (1.1), and wherein the actuating element (3) that cooperates with the valve body (2) is arranged in the other of the two housing sections (1.2).

2. The non-return valve according to claim 1,
wherein
a guide device (4) is provided on one of the two housing sections (1.2) for a retaining element (5) that can be brought into operative connection with the other housing section (1.1).

3. The non-return valve according to claim 2,
wherein
the retaining element (5) is designed to cause a displacement of the housing sections (1.1, 1.2) towards each other when the retaining element (5) is inserted in the guide device (4).

4. The non-return valve according to claim 2,
wherein
an adjusting element (6) which cooperates with the retaining element (5) is provided on the outside of the housing section (1.1) that accommodates the valve body (2) in order to displace the housing sections (1.1, 1.2) towards each other.

5. The non-return valve according to claim 4,
wherein
an abutment member (7) that is connected firmly but detachably to the housing section (1.2) that accommodates the actuating element (3) is assigned to the adjusting element (6).

6. The non-return valve according to claim 4,
wherein
to displace the housing sections (1.1, 1.2) towards each other the retaining element (5) is designed to be insertable between the adjusting element (6) and the abutment member (7) to press them apart.

7. The non-return valve according to claim 5,
wherein
the abutment member (7) is designed as a limit stop for the adjusting element (6) to prevent the housing sections (1.1, 1.2) from becoming detached from each other.

8. The non-return valve according to claim 2,
wherein
the guide device (4) has a passthrough opening (4.1) to allow the retaining element (5) to be inserted.

9. The non-return valve according to claim 8,
wherein
the passthrough opening (4.1) has a side (4.1.1) facing towards the valve housing (1) and a side (4.1.2) facing away from the valve housing (1).

10. The non-return valve according to claim 9,
wherein
while acting on the housing sections (1.1, 1.2), the retaining element (5) has a blocking part (5.1) that remains on the side (4.1.2) of the passthrough opening (4.1) facing away from the valve housing (1).

11. The non-return valve according to claim 9,
wherein
the side (4.1.2) of the passthrough opening (4.1) facing away from the valve housing (1) is designed to serve as a bearing surface for a housing part (8) when the retaining element (5) is not inserted.

12. The non-return valve according to claim 2,
wherein
a stowing device (9) is provided on the valve housing (1) to stow the retaining element (5) when the retaining element (5) is not in use.
